(19) United States
(12) Patent Application Publication
(10) Pub. No.: US 2026/0259614 A1
(43) Pub. Date: Sep. 3, 2026

(54) Electronic Information Input Apparatus Having Multiple Operation Modes and Method for Switching Operation Modes

(71) Applicant: Shengmin Wen, Phoenix, AZ (US)

(72) Inventor: Shengmin Wen, Phoenix, AZ (US)

(21) Appl. No.: 18/899,764

(22) PCT Filed: Oct. 1, 2023
(86) PCT No.: PCT/US2023/075663

§ 371 Date: Sep. 27, 2024

(51) Int. Cl. G06F 3/02; G06F 3/0354

(52) U.S. Cl. CPC G06F 3/0202; G06F 3/03547

(57) ABSTRACT

An electronic information input apparatus is described herein. In one or more implementations, an electronic information input apparatus has a first side having a keyboard subassembly, a second side that is opposite to the first side having a writing tablet subassembly, and a main body housing that provides a stiffener plate as the structural base in between the keyboard subassembly and the writing tablet subassembly. Users can switch between the typing input or writing input anytime with just a physical flip of the apparatus. The apparatus is thin and light and can be configured to couple and communicate to an input/output module of any computing device through wired or wireless means. The apparatus can be physically separated from a computing device and used in a detached mode or can be an integrated part of a computing device. The apparatus is also shareable among different computing devices.

### CROSS-REFERENCE TO RELATED APPLICATIONS

The application is a U.S. national stage entry of International Application No. PCT/US2023/075663 Oct. 1, 2023, which is incorporated by reference herein.

### BACKGROUND OF THE INVENTION

Keyboard has been the input of choice for a computing device, for example, the computers and electronic instruments. The keyboard input method involves either a combined mechanical/electrical mechanism where user physically depresses a key to produce electrical output signal or a touch sensing mechanism where user touches a virtual digital image of a key with finger or stylus to generate electrical output signal. Both mechanisms use a set of limited number of discrete keys. It is impossible to use a keyboard of any sort to draw a free form sketch, to take a handwriting digital note when reading an electronic document or an e-book, to sign online documentation or annotate an online presentation, or to provide handwriting as a base mode of input. To carry out above mentioned much needed tasks in the digital age, an apparatus that is specially designed to provide handwriting input is a must. However, users have not been able to use handwriting as a base mode of input to a computing device like computers and electronic systems until very recently after the introduction of touch display technology for computers when users can input handwriting into computer with their fingers or a specially designed stylus or pen on a touch display. The handwriting on touch display inherently lags noticeably due to circuitry latency, resulting in bad user experience. In addition, writing on hard display glass does not provide a natural paper like writing experience.

It is the objective of this invention to provide an electronic apparatus that has typing input and handwriting input modes, where an added handwriting mode provides natural paper like writing experience without any latency, and to switch between typing and handwriting input modes is fast, smooth and easy.

### BRIEF SUMMARY OF THE INVENTION

Broadly speaking, the invention pertains to a new electronic information input apparatus, and more specifically, an electronic apparatus providing multiple input modes and a method of switching among these input modes. The apparatus has a first side as a traditional keyboard and a second side as a writing tablet that provides user with normal writing experience, including coarse or fine line drawings, variable stroke thickness through the control of pen tip pressure, pen tilt or writing speed, and calligraphic artistic effects. In a normal use condition, users can switch these two types of input mode by simply flipping the apparatus in a matter of seconds. The apparatus can be used to connect to any computing device, such as a computer, a mobile phone, a television, or an industrial instrument.

Other aspects and advantages of the invention will become apparent from the following detailed description, taken in conjunction with the accompanying drawings, illustrating by way of example the principles of the invention.

### BRIEF DESCRIPTION OF THE SEVERAL VIEWS OF THE DRAWING

The invention, together with further advantages thereof, may best be understood by reference to the embodiment(s) shown in conjunction with the accompanying drawings, in which:

FIG. 1 is a pictorial view showing an application configuration of an electronic information input apparatus according to an embodiment of this invention;

FIG. 2A is a perspective drawing showing one embodiment of the information input apparatus of the aforesaid invention;

FIG. 2B is a schematic, partially cross-sectional drawing illustrating the construction of the apparatus of the aforesaid invention;

FIG. 3 is a partially exploded, cross-sectional schematic drawing illustrating the functional layer structure and essential elements of the input apparatus of the aforesaid invention;

FIG. 4A is a diagram view showing the layer stacking of the writing tablet including the writing surface, the sensing element, and an associated position indicator in the form of a pen;

FIG. 4B is an illustration view showing the construction of the sensing element based on electromagnetic principles for the writing tablet;

FIG. 5A is a diagram view showing the stacking of the writing tablet including the writing surface, the sensing element, and a finger or human body;

FIG. 5B is an illustration view showing construction of the sensing element based on the capacitive principle for the writing tablet;

FIG. 6 is a pictorial drawing showing the method of switching among operation modes of the apparatus;

FIG. 7 depicts an example implementation of an electronic information input apparatus having multiple operation modes in which key presses are detected using a keyboard controller and writing actions by the position indicator are detected using a position process unit, a communication unit being utilized to communicate the key presses or writing actions to the input/output interface of a computing device;

FIG. 8 illustrates an example system including various components of an example device that can be implemented as any type of computing device as described with reference to FIGS. 1-7 to implement the techniques described herein;

FIG. 9A is a pictorial view of a user using an example typing input mode;

FIG. 9B is a pictorial view of a user using an example handwriting input mode.

FIG. 10 is an abstract figure of the electronic information input apparatus of this invention.

### DETAILED DESCRIPTION OF THE INVENTION

Conventionally, to input electronic information to a computing device, like computers or electronic instruments, involves apparatus like a keyboard, a mouse, and a pen tablet. Each one of these apparatuses is a standalone peripheral piece with its individual connection to the computer device or the instrument. It is very inconvenient to use them all in the same working settings. Mobile computing devices do not have many connections available due to their design and form factor limitations. It is extremely inconvenient for the users to carry these input apparatuses with the computing device. The apparatus described herein have all the input methods integrated together. The apparatus is thin and light, draws less power, meets today's mobile electronic devices needs, takes smaller working space, is less expensive, and reduces traditional paper usage to bring environment benefits. The input apparatus can either be physically separated from the computing device or be implemented as a physical part of the computing device.

In one or more implementations, an apparatus includes a three-element structure. The three-element structure includes a first element, a second element, and a housing element that includes a stiffener plate that is positioned between the first and second element. The first element is a keyboard element that includes a plurality of keys and an associated electronic circuit. The second element is a writing tablet that includes a writing surface and its associated electromagnetic induction sensing layering structure, and a position indicator (refer to as a pen in following description) with electromagnetic resonant circuit for the writing input.

In one or more implementations, an apparatus includes a three-element structure. The three-element structure includes a first element, a second element, and a housing element that includes a stiffener plate that is positioned between the first and second element. The first element is a keyboard element that includes a plurality of keys and an associated electronic circuit. The second element is a writing tablet that includes a writing surface and its associated capacitive sensing layering structure where a user uses finger or a stylus for the writing input.

In one or more implementations, an apparatus includes a three-element structure. The three-element structure includes a first element, a second element, and a housing element that includes a stiffener plate that is positioned between the first and second element. The first element is a keyboard element that includes a plurality of keys and an associated electronic circuit. The second element is a writing tablet that includes a writing surface, its electromagnetic induction sensing layering structure together with a pen having an electromagnetic resonant circuit, plus an overlaid capacitive sensing layering structure.

In one or more implementations, an apparatus includes a three-element structure. The three-element structure includes a first element, a second element, and a housing element that includes a stiffener plate positioned between the first and second element. The first element includes a keyboard that includes a plurality of keys, an integrated touch pad, and an associated electronic layering structure on the first side. The second element is a writing tablet that includes a writing surface and its associated electromagnetic induction sensing layering structure on the second side, and a pen with electromagnetic resonant circuit for the writing input.

In one or more implementations, an apparatus includes a three-element structure. The three-element structure includes a first element, a second element, and a housing element that includes a stiffener plate positioned between the first and second element. The first element includes a keyboard that includes a plurality of keys, an integrated touch pad, and their associated electronic circuit on the first side. The second element is a writing tablet that includes a writing surface and its associated capacitive sensing layering structure where a user uses fingers or stylus for the writing input.

In one or more implementations, an apparatus includes a three-element structure. The three-element structure includes a first element, a second element, and a housing element that includes a stiffener plate positioned between the first and second element. The first element includes a keyboard that includes a plurality of keys, an integrated touch pad, and an associated electronic circuit on the first side. The second element is a writing tablet that includes a writing surface, its electromagnetic induction sensing layering structure together with a pen having electromagnetic resonant circuit, plus an overlaid capacitive sensing layering structure that interacts with user fingers or stylus for the writing input.

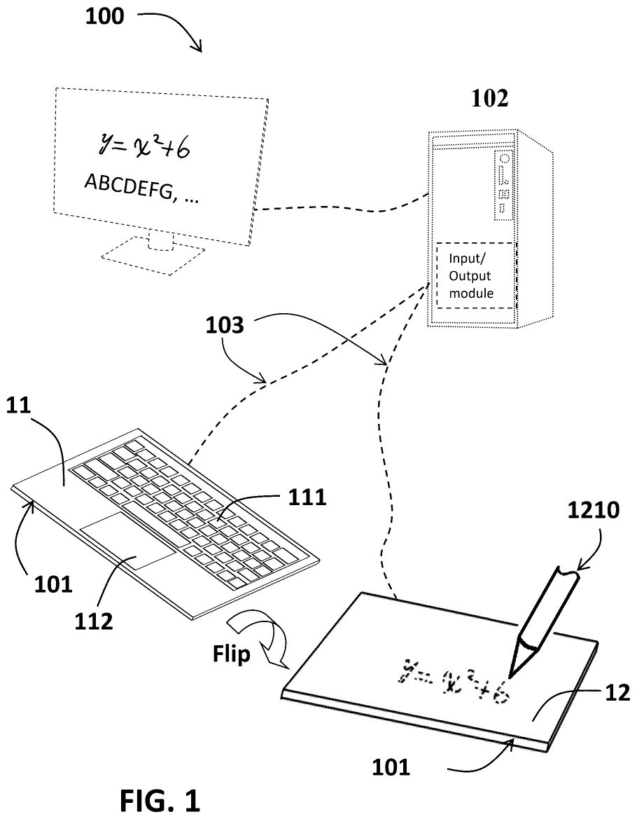

FIG. 1 is an illustration of an environment 100 in an example implementation that is operable to employ the electronic information input apparatus described herein. The illustrated environment 100 includes an example of a computing device 102 that is physically and communicatively coupled to the electronic information input apparatus 101. In this example, the computing device 102 is physically and communicatively coupled to the electronic information input apparatus 101 via USB cable 103, however other connection mechanisms, such as Bluetooth, Wi-Fi, or radio frequency (RF) data transfer are also contemplated. The computing device 102 may be configured in a variety of ways. For example, the computing device 102 may be configured for mobile use, such as a mobile phone, a notebook computer, a tablet computer, a smart TV, and so on. Thus, the computing device 102 may range from full resource devices with substantial memory and processor resources to a low-resource device with limited memory and/or processing resources. The computing device 102 may also relate to software that causes the computing device 102 to perform one or more operations.

The computing device 102 has an input/output module (which is standard therefore it is not shown here for simplicity) to process input information communicated from the electronic information input apparatus 101 and render outputs of the computing device 102. This input/output module process a variety of different inputs, such as inputs relating to functions that correspond to key depress of the keyboard 111 on the first side of the input apparatus 101, the pen or finger movement on the surface of writing tablet 12 on the second side of the input apparatus 101, the touch operation from the touchpad 112 on the first side of the input apparatus 101, and so forth. Thus, the input/output module of computing device 102 may support a variety of different input techniques by recognizing and leveraging a division between types of inputs including key depresses, touch movements, pen movements and strokes, user finger movements, and so on.

In the illustrated example embodiment 101, the first side of the input apparatus 101 functions as a regular keyboard or a keyboard/touchpad combination 11 that has an input portion that includes keys 111 and an integrated touchpad 112 by the side. The touchpad 112 in the illustrated example is formed as a rectangle shape having four corners, although other shapes are also contemplated. The number of keys 111 and their arrangements can be customized, and the touchpad choice can vary per targeted user preference. In some cases, the keyboard 11 on the first side can be without a touchpad and may just include a standard mechanical keyboard or non-conventional configurations of a keyboard having keys as game controller or musical instrument and so on.

In the illustrated example embodiment 101, a user can flip the input apparatus 101 to have the second side facing up. This second side of the input apparatus 101 functions as a writing tablet 12, having a writing surface and a coupled position indicator pen 1210. Users can either use a coupled position indicator pen 1210 or their fingers to generate input information which will communicate to the input/output module of the computing device 102. An electromagnetic induction mechanism may be used for the position indicator pen application and a capacitive sensing mechanism may be used for the stylus and/or finger application.

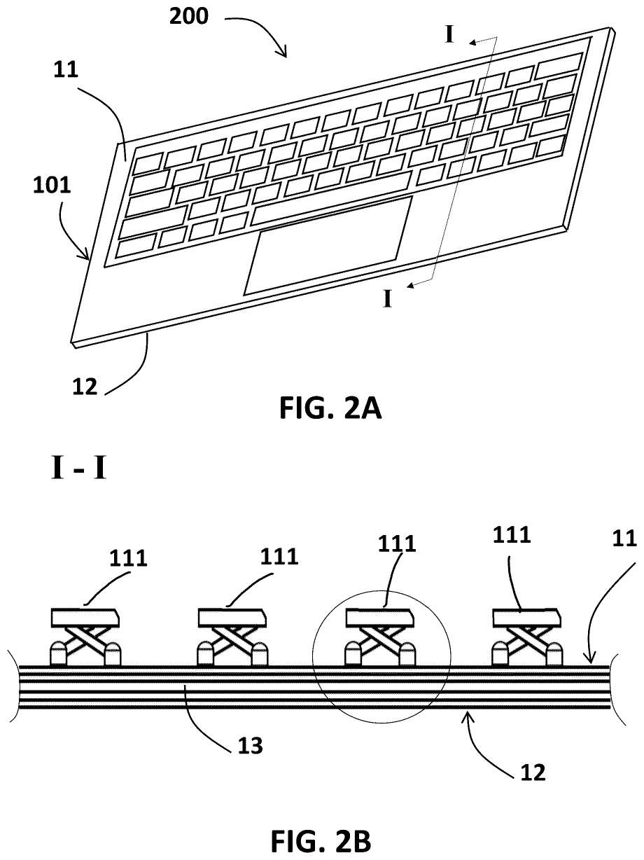

FIG. 2A depicts perspective view of the electronic information input apparatus 101 of FIG. 1 as an example implementation 200. Keys and touchpad side by side as keyboard combination 11 is arranged on the first side while writing tablet 12 is arranged on the second side that is opposite to the first side, although this arrangement may also be altered or reversed without departing from the spirit and scope thereof.

FIG. 2B depicts an example partial cross-section view I-I of the apparatus 101 of FIG. 2A in accordance with one or more implementations. In this example, a first side houses the keyboard subassembly 11 with keys 111 (showing four keys in this drawing) for key depress input, a second side houses the writing tablet subassembly 12 for writing input, and a stiffener plate 13 is sandwiched in between these two functional subassemblies. The stiffener plate layer 13 provides brackets (not showing here the details as the structure is standard) to anchor the keys of the keyboard 11, provides base for the lamination of the multilayer layering structure for the writing tablet, and provides spaces to install controllers, power management units as well as communication electronic units such as Wi-Fi and/or Bluetooth units (not show here for simplicity).

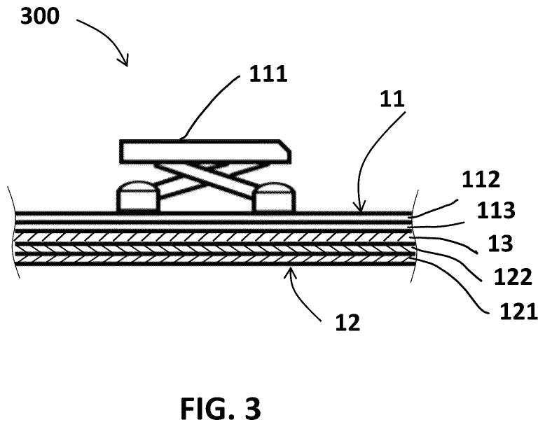

FIG. 3 is an exploded schematic view 300 of the structural cross-section I-I of the apparatus 101 depicting exemplary construction details that include just one example key 111. The stiffener plate 13 is light weight, flat, and strong. It may be built with metal such as aluminum, titanium, carbon fiber reinforced plastic, or it may be built with a functional PCB of proper stiffness. Plate 13 is the base that supports the vertical movement of the keys 111 for the key depress of typing input on the first side and supports a flat surface for the lamination of paper like surface for the handwriting input on the second side. The keyboard for typing comprises three essential elements that are stacked on top of each other on plate 13. The first element is the key set 111 that provides the typing input interface and has a switch mechanism that is designed to have an ergonomic travel distance typically within the range of 0.5 mm to 4.0 mm when a key is depressed. The second element is an electrical circuitry layer 112 that is below the key set 111 and generates signals collected by the typing input controller (not shown here in the figures) when a key is depressed. This electrical circuitry layer may be a composite structure that includes a three-layer membrane, where metal traces on the two outer layers separated by a center layer with holes can be shorted through the holes when a key is depressed. The third element 113 is typically the bracket where keys 111 are attached or anchored. The writing tablet for writing input also comprises three major elements. A first element is the cover layer 121 which is a specially treated flat surface that provides paper like writing experience. A second element is a sensor 122 that is vacuum laminated on stiffener plate 13. Sensor 122 is a layering structure and is sandwiched between the support plate 13 and the writing surface layer 121. More details of the sensor 122 are discussed below according to various mechanisms or a combination of two or more mechanisms.

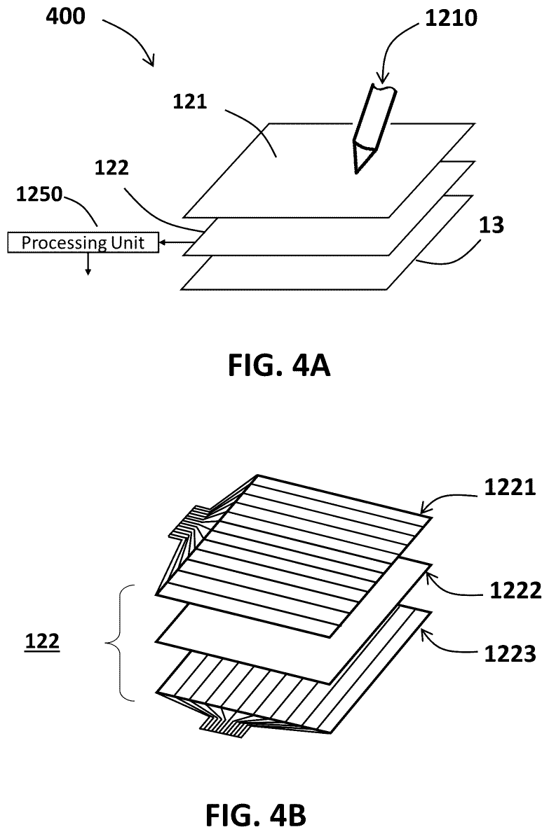

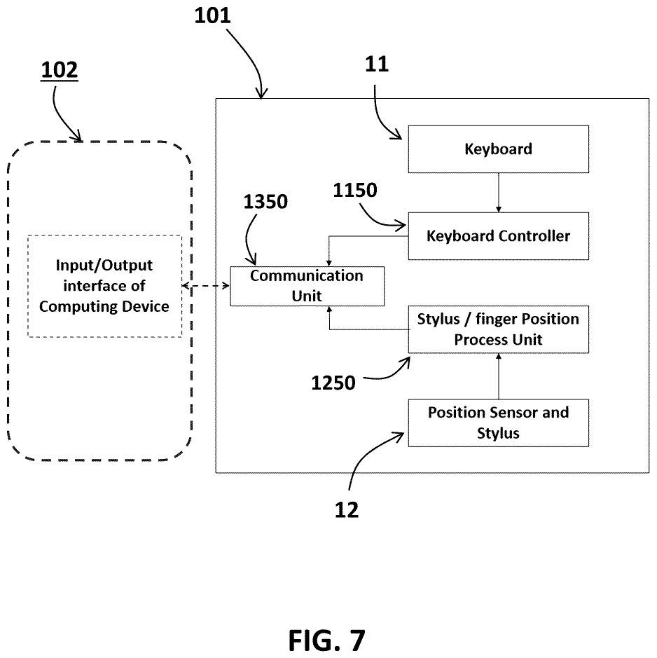

FIG. 4A depicts an exploded schematic configuration view 400 of the writing tablet 12 of the apparatus 101 of FIG. 1 in accordance with one or more implementations. In this example, sensor 122 is sandwiched between writing surface 121 and stiffener 13. Sensor 122 interacts with the associated position indicator pen 1210 through electromagnetic induction and resonance principle, generating signals that are collected by a processing unit 1250 as a position data. The processing unit 1250 sends this position data to an onboard communication unit 1350 (shown in FIG. 7) that in turn communicates to an input/output module of the computer device 102. FIG. 4B depicts an exploded perspective view of the sensor 122 of the writing tablet 12 of the apparatus 101 of FIG. 1. In the example, layer 1221 and layer 1223 has rectangular shaped metal coil patterns that are perpendicular to each other, and layer 1222 is an insulation layer between layer 1221 and 1223. Layer 1221 and layer 1223 provides the X-Y coordinates of the location of a position indicator pen 1210 when the pen approaches or is in contact with the writing surface 1221. Sensor 122 may be provided with a voltage and power. Other choice include that the sensor 122 does not use a power supply but the position indicator pen 1210 has power supply in an active mode. It is preferable to supply the pen with power and keep the sensor 122 stand-by to achieve low power operation.

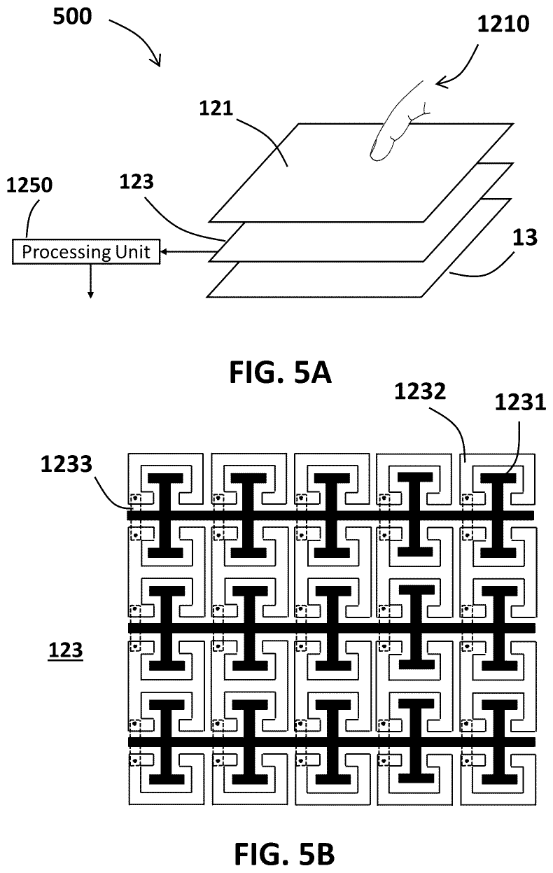

FIG. 5A depicts yet another example 500 of the writing tablet 12 of the apparatus 101 of FIG. 1 in accordance with one or more implementations. In this example, sensor 123 is sandwiched between writing surface 121 and stiffener 13. Sensor 123 senses the approaching or touch action of a human finger or a stylus or the like to the surface 121 through a change of capacitance associated with the local electric field that is detected by a processing unit 1250 and converted into a position data. The processing unit 1250 sends this position data to an onboard communication unit 1350 (shown in FIG. 7) that in turn communicates to an input/output module of the computer device 102 as writing input information.

The sensor 123 takes special form and pattern and is connected to the processing unit. FIG. 5B illustrates an exemplary sensing layer 123 in accordance with an embodiment. The sensor 123 may take the form of a 2-layer PCB structure. A 2-layer PCB structure has one copper metal layer on each side of a core layer which is an insulation layer. On a first side includes an array of copper metal sensor electrodes 1231 and 1232 arranged in a periodic manner. Electrodes 1231 are arranged in one direction. A portion of each sensor electrode element 1232 is arranged between sensor electrodes 1231. Electrodes 1232 are ohmically isolated from each other as well as from 1231. Those sensor electrode elements 1232 in the same column are ohmically connected by vias through the core layer and metal connecting elements 1233 (shown by the dashed line) on a second side to form an electrode that may be orthogonal to the direction of electrodes 1231. Electrodes 1231 may function as receiver electrode and electrodes 1232 transmitter electrodes. Electrodes 1231 and 1232 form a uniform electric field. When a stylus or a human finger 1210 approach or touch the surface 121, there is a change in capacitive coupling to the electric field at the touch location. The process unit 1250 can detect the location and communicate that location to an onboard communication unit 1350 (shown in FIG. 7). The sensor 123 may also take the form of a 2-layer film structure.

While FIGS. 4 and 5 illustrate two exemplary sensors of the writing tablet 12 of the apparatus 101 of FIG. 1, one of ordinary skill in the art would recognize that the sensing mechanism of writing tablet can use different mechanisms such as resistive, self-capacitance, mutual capacitance, and so on.

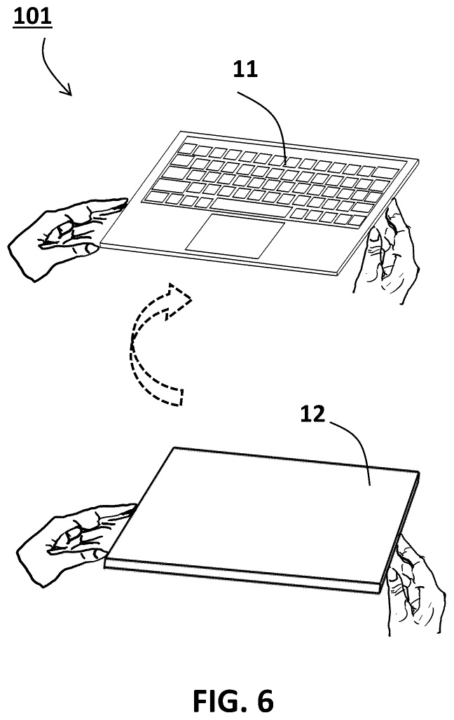

FIG. 6 illustrates the method for switching operation modes. It is simple and straight forward by flipping the apparatus from the keyboard 11 facing up to writing tablet 12 facing up, and vice versa. Within a couple of seconds, the input mode is switched per user's information input needs.

FIG. 7 depicts an operation flow diagram of an exemplary implementation of an electronic information input apparatus having multiple operation modes. Any key depress on the keyboard subassembly 11 is detected by a keyboard controller 1150 and transmitted to the communication unit 1350 which in turn communicates to the input/output module of a computing device 102. Similarly, any writing action and interaction between the writing tablet 12 and stylus 1210 are detected by a position process unit 1250 which in turn communicates to the input/output module of a computing device 102.

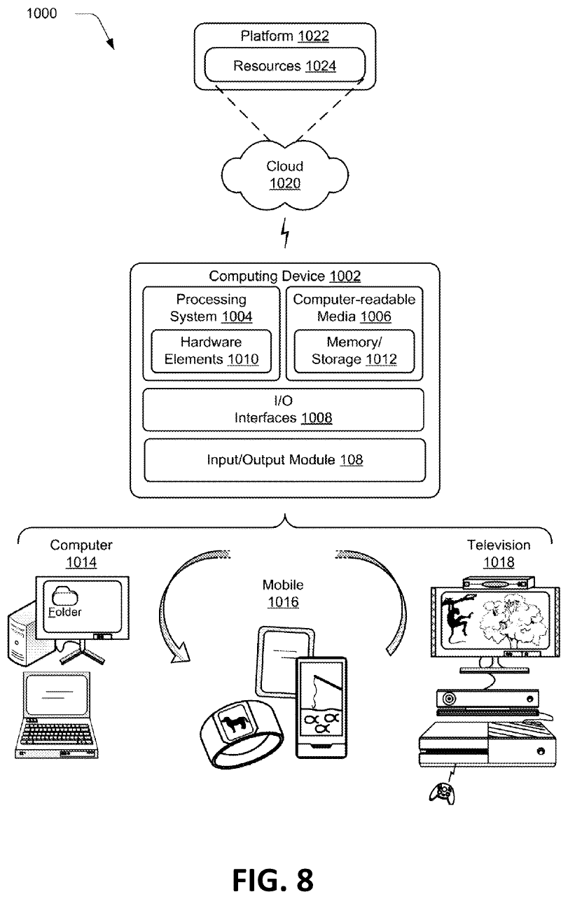

FIG. 8 illustrates an example system generally at 1000 that includes an example computing device 1002 that is representative of one or more computing systems and/or devices that may implement the various techniques described herein. This is illustrated through inclusion of the input/output module 108. The computing device 1002 may be, for example, a server of a service provider, a device associated with a client (e.g., a client device), an on-chip system, and/or any other suitable computing device or computing system.

The example computing device 1002 as illustrated includes a processing system 1004, one or more computer-readable media 1006, and one or more I/O interface 1008 that are communicatively coupled, one to another.

The processing system 1004 is representative of functionality to perform one or more operations using hardware. Accordingly, the processing system 1004 is illustrated as including hardware element 1010 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1006 is illustrated as including memory/storage 1012. The memory/storage 1012 represents memory/storage capacity associated with one or more computer-readable media.

Input/output interface(s) 1008 are representative of functionality to allow a user to enter commands and information to computing device 1002, and also allow information to be presented to the user and/or other components or devices using various input/output devices.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1002. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1002, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

In various implementations, the computing device 1002 may assume a variety of different configurations, such as for computer 1014, mobile 1016, and television 1018 uses. Each of these configurations includes devices that may have generally different constructs and capabilities, and thus the computing device 1002 may be configured according to one or more of the different device classes. For instance, the computing device 1002 may be implemented as the computer 1014 class of a device that includes a personal computer, desktop computer, a multi-screen computer, laptop computer, netbook, and so on.

The computing device 1002 may also be implemented as the mobile 1016 class of device that includes mobile devices, such as a mobile phone, wearables (e.g., wrist bands, pendants, rings, etc.) portable music player, portable gaming device, a tablet computer, a multi-screen computer, and so on. The computing device 1002 may also be implemented as the television 1018 class of device that includes devices having or connected to generally larger screens in casual viewing environments. These devices include televisions, set-top boxes, gaming consoles, and so on. Other devices are also contemplated, such as appliances, thermostats and so on as part of the “Internet of Things.”

The techniques described herein may be supported by these various configurations of the computing device 1002 and are not limited to the specific examples of the techniques described herein. This functionality may also be implemented all or in part through use of a distributed system, such as over a “cloud” 1020 via a platform 1022 as described below.

The cloud 1020 includes and/or is representative of a platform 1022 for resources 1024. The platform 1022 abstracts underlying functionality of hardware (e.g., servers) and software resources of the cloud 1020. The resources 1024 may include applications and/or data that can be utilized while computer processing is executed on servers that are remote from the computing device 1002. Resources 1024 can also include services provided over the Internet and/or through a subscriber network, such as a cellular or Wi-Fi network.

The platform 1022 may abstract resources and functions to connect the computing device 1002 with other computing devices. The platform 1022 may also serve to abstract scaling of resources to provide a corresponding level of scale to encountered demand for the resources 1024 that are implemented via the platform 1022. Accordingly, in an interconnected device, implementation of functionality described herein may be distributed throughout the system 1000. For example, the functionality may be implemented in part on the computing device 1002 as well as via the platform 1022 that abstracts the functionality of the cloud 1020.

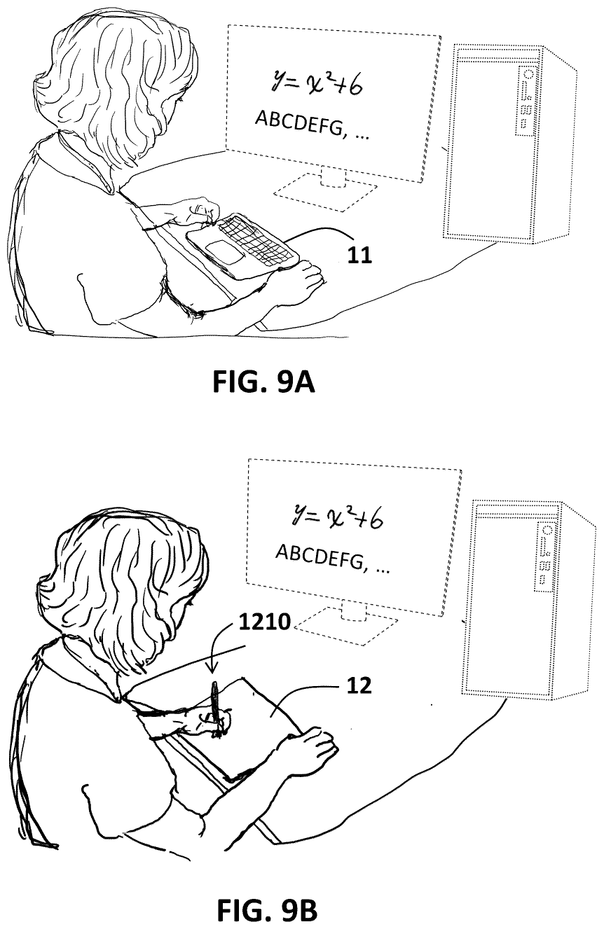

FIGS. 9A and 9B are pictorial views of a user using the typing and handwriting input mode of the electronic information input apparatus of this invention per different input needs in two situations respectively. FIG. 9A illustrates the user uses keyboard mode 11 of the apparatus, while FIG. 9B illustrates the user uses writing tablet mode 12 of the apparatus with a pen/stylus 1210 to input handwritings.

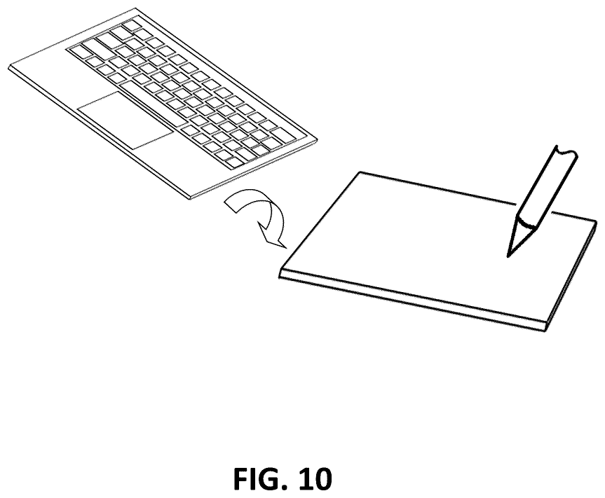

FIG. 10 is an abstract figure of the electronic information input apparatus of this invention.

The electronic information input apparatus 101 of FIG. 1 can be physically separate from the computing device as illustrated here or can be implemented as a physical part of the computing device 102. As appropriate, the input apparatus 101 may communicate with input/output module of a computing device using any one or more of the following means: buses, networks, and other wired or wireless interconnections. Examples include I2C, SPI, PS/2, Universal Serial Bus (USB), Wi-Fi, Bluetooth, RF, and Infrared Data Association (IRDA).

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

1-23. (canceled)

24. An electronic information input apparatus comprising:
a keyboard subassembly including a plurality of keys, an electrical circuitry layer to generate keyboard signals responsive to interactions with the keys, and a bracket layer for anchoring the keys;
a writing tablet subassembly including a writing surface and a sensor layer for sensing writing interactions with the writing surface and generating writing signals indicative of the writing interactions;
a stiffener plate having a first surface directly coupled to the bracket layer of the keyboard subassembly to provide structural support for the plurality of keys, and the stiffener plate having a second surface opposite the first surface, wherein the sensor layer of the writing tablet subassembly is directly laminated on the second surface of the stiffener plate; and
a communication unit to communicate the keyboard signals and the writing signals to an input/output module of a computing device.

25. The electronic information input apparatus of claim 24, wherein each key of the keyboard subassembly has a key-switch mechanism allowing the key to move downward when the key is depressed, wherein depressing the key activates a switch of the electrical circuitry to encode a key press in the keyboard signals communicated by the communication unit.

26. The electronic information input apparatus of claim 25, wherein the keyboard subassembly further comprising an integrated touchpad or pointing device positioned side by side adjacent to the plurality of keys, the integrated touchpad or point device generating electrical signals for controlling movement of a cursor in the computing device.

27. The electronic information input apparatus of claim 25, wherein a travel distance of the plurality of keys are in the range of 0.5 millimeters to 5.0 millimeters.

28. The electronic information input apparatus of claim 24, further comprising:
a position indicator device in the form of a pen or stylus for interacting with the writing surface.

29. The electronic information input apparatus of claim 28, wherein the writing tablet subassembly further comprises a process unit to generate positional output data in response to movement of the position indicator relative to the writing surface.

30. The electronic information input apparatus of claim 29, wherein the positional output data is delivered by the communication unit to the input/output module of the computing device.

31. The electronic information input apparatus of claim 24, wherein the sensor layer includes an electromagnetic resonance (EMR) sensor comprising a layering structure having a plurality of patterned coils configured to electromagnetically couple with a resonant circuit of an EMR position indicator device to produce an electrical signal corresponding a position indicated by the EMR position indicator on or above the EMR sensor under the writing surface.

32. The electronic information input apparatus of claim 24, wherein the sensor layer comprises a capacitive touch sensor, the capacitive touch sensor including electrodes patterns configured to capacitively couple with a capacitive position indicator to produce an electrical signal corresponding to position indicated by the position indicator on or above the capacitive touch sensor under the writing surface.

33. The electronic information input apparatus of claim 24, wherein the sensor comprising an integrated capacitive touch sensor and an electromagnetic resonance (EMR) sensor overlaid with each other to couple with a position indicator to produce an electrical signal corresponding to position indicated by the position indicator on or above the writing surface.

34. The electronic information input apparatus of claim 24, wherein the communication unit has a physical communication connection to the input/output module of the computing device, the physical communication connection comprising at least one of a Universal Serial Bus (USB) connection or a PS/2 cable.

35. The electronic information input apparatus of claim 24, wherein the communication unit has a wireless connection to the input/output module of the computing device, the wireless connection comprising at least one of: Bluetooth, Wi-Fi, and a Radio Frequency (RF) data transmitting/receiving connection.

36. The electronic information input apparatus of claim 24, wherein the stiffener plate comprises a diagonal length of no less than 200 millimeters.

37. The electronic information input apparatus of claim 24, wherein the electronic information input apparatus is operable in at least a keyboard mode for a user to provide typing input, and a writing tablet mode for a user to input handwriting and drawing input.

38. The electronic information input apparatus according to claim 37, wherein the electronic information input apparatus is further operable in a third mode in which a touchpad or pointing devices enables movement of a cursor or execution of dropdown menu-based commands.

39. The electronic information input apparatus of claim 24, wherein the electronic information input apparatus is operable in at least two operation modes including a keyboard mode and a writing mode, wherein the electronic information input apparatus is configured to switch between the at least two operating modes in response to detecting a physical flipping of the electronic information input.

40. A computer system comprising:
a computer device having an input/output module; and
an electronic information input apparatus comprising:
a keyboard subassembly including a plurality of keys, an electrical circuitry layer to generate keyboard signals responsive to interactions with the keys, and a bracket layer for anchoring the keys;
a writing tablet subassembly including a writing surface and a sensor layer for sensing writing interactions with the writing surface and generating writing signals indicative of the writing interactions;
a stiffener plate having a first surface directly coupled to the bracket layer of the keyboard subassembly to provide structural support for the plurality of keys, and the stiffener plate having a second surface opposite the first surface, wherein the sensor layer of the writing tablet subassembly is directly laminated on the second surface of the stiffener plate; and
a communication unit to communicate the keyboard signals and the writing signals to the input/output module of the computing device.

41. The computer system of claim 40, wherein the electronic information input apparatus is operable in at least two operation modes including a keyboard mode and a writing mode, wherein the electronic information input apparatus is configured to switch between the at least two operating modes in response to detecting a physical flipping of the electronic information input.

42. A method of constructing an electronic information input apparatus:
integrating a keyboard controller, a writing tablet process unit, and a communication unit onto a printed circuit board (PCB) to form a PCB system;
securing a keyboard subassembly on brackets on a first side of a stiffener plate;
laminating with adhesive a writing tablet subassembly directly onto a second side of the stiffener plate that is opposite the first side;
installing the PCB system onto the stiffener; and
connecting the keyboard subassembly to the keyboard controller and connecting the writing tablet subassembly to the writing tablet process unit.

43. The method according to claim 42, further comprising:
integrating a power delivery system, a memory, a microcontroller, and a battery component into the PCB system.
